(19) United States
(12) Patent Application Publication
(10) Pub. No.: US 2008/0302926 A1
(43) Pub. Date: Dec. 11, 2008

(54) DISPLAY DEVICE AND ELEVATOR SUPPORT STRUCTURE THEREOF

(75) Inventors: Kang-Han Cheng, Taipei County (TW); Wei-Hsin Hsu, Taipei County (TW); Chun-Jung Tsuo, Taoyuan County (TW); Yung-Chun Su, Taipei County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 12/135,949

(22) Filed: Jun. 9, 2008

(30) Foreign Application Priority Data
Jun. 11, 2007 (TW) TW96120933
Nov. 2, 2007 (TW) TW96141350

(51) Int. Cl. F16M 11/38

(52) U.S. Cl. 248/161

(57) ABSTRACT

A display comprises a display unit, and an elevator support structure, wherein the elevator support structure comprises a base, a first connecting element, a second connecting element, and a middle hinge assembly. The first connecting element is pivotally connected to the display unit, wherein the first connecting element rotates relative to the display unit around a first axis. The second connecting element is connected to the base, wherein the second connecting element rotates relative to the base around a second axis. The middle hinge assembly is pivotally connected to the first connecting element and the second connecting element, wherein the first connecting element rotates relative to the middle hinge assembly around a third axis, the second connecting element rotates relative to the middle hinge assembly around a fourth axis. The first, second, third and fourth axes are perpendicular to the display area.

### BACKGROUND OF THE INVENTION

1. Field of the Invention

The present invention relates to a display device, and in particular relates to a display device with an adjustable elevator support structure.

2. Description of the Related Art

Referring to FIGS. 10a and 10b, a conventional display device 100 consists of a display unit D, a link L, and a base B. Both ends of the link L are pivotally connected to the display unit D and the base B, respectively. The altitude of the display unit D can be changed by adjustment of the orientation of the link L as shown in FIG. 10b.

During the adjustment of the link L, the center of gravity of the display device 100 may be shifted out of the base B so that the display device 100 tips upward. This problem can be solved by enlargement of the base B. However, the display device 100 becomes cumbersome and the manufacturing cost is increased.

### BRIEF SUMMARY OF THE INVENTION

A detailed description is given in the following embodiments with reference to the accompanying drawings.

The invention provides an elevator support structure without forward and backward movement during an adjustment of the altitude of a supported object and without occupying excessive volume.

The invention provides an elevator support structure comprising a first connecting element, a second connecting element, a pair of transmission elements, a top hinge, a joint, a first middle hinge, a second middle hinge, a linking element, a base, a bottom hinge, a first linkage and a second linkage. The first connecting element has a first lower end and a first upper end. The second connecting element has a second lower end and a second upper end connected to the first lower end of the first connecting element. The pair of transmission elements respectively connected the first lower end of the first connecting element and the second upper end of the second connecting element to rotate in opposite directions. The top hinge is pivotally connected to the first upper end of the first connecting element. The joint is connected to the top hinge. The first middle hinge is pivotally connected to the first lower end of the first connecting element and one of the transmission elements. The second middle hinge is pivotally connected to the second upper end of the second connecting element and the other of the transmission elements. The linking element is connected to the first connecting element and the second connecting element. The bottom hinge is pivotally connected to the second lower end of the second connecting element and the base. The first linkage is connected the top hinge and the first middle hinge. The second linkage is connected the second middle hinge and the bottom hinge, wherein when the pair of the transmission elements are rotated in opposite directions, and the first and second connecting elements are respectively rotated with respect to the first and second middle hinges and the joint and the linking element are vertically moved with respect to the base.

The invention provides a display comprising a display unit, and an elevator support structure, wherein the elevator support structure comprises a base, a first connecting element, a second connecting element, and a middle hinge assembly. The first connecting element is pivotally connected to the display unit, wherein the first connecting element rotates relative to the display unit around a first axis. The second connecting element is connected to the base, wherein the second connecting element rotates relative to the base around a second axis. The middle hinge assembly is pivotally connected to the first connecting element and the second connecting element, wherein the first connecting element rotates relative to the middle hinge assembly around a third axis, the second connecting element rotates relative to the middle hinge assembly around a fourth axis. The first, second, third and fourth axes are perpendicular to the display area.

### BRIEF DESCRIPTION OF THE DRAWINGS

The present invention can be more fully understood by reading the subsequent detailed description and examples with references made to the accompanying drawings, wherein:

FIG. 1 is an exploded view of an elevator support structure in accordance with an embodiment of the invention.

FIG. 2 is an exploded view of a base in accordance with the embodiment of the invention.

FIG. 3 is an exploded view of a joint in accordance with the embodiment of the invention.

FIG. 4 is a stereogram of an elevator support structure in accordance with the embodiment of the invention.

FIG. 5 is a stereogram of an adjusted elevator support structure in accordance with the embodiment of the invention.

FIG. 6 is an assembly drawing of an elevator support structure and a display unit in accordance with the embodiment of the invention.

FIGS. 7a and 7b depict the elevating process of a display unit in accordance with the embodiment of the invention.

FIG. 8a is a stereogram of the display unit D at the so-called “Portrait” position.

FIG. 8b is a rear view of the display unit D shown in FIG. 8a.

FIG. 9a is a stereogram of a display device in a compact volume.

FIG. 9b is a lateral view of the display device shown in FIG. 9a.

FIGS. 10a and 10b are schematic views of a conventional display device and the elevator support structure thereof.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

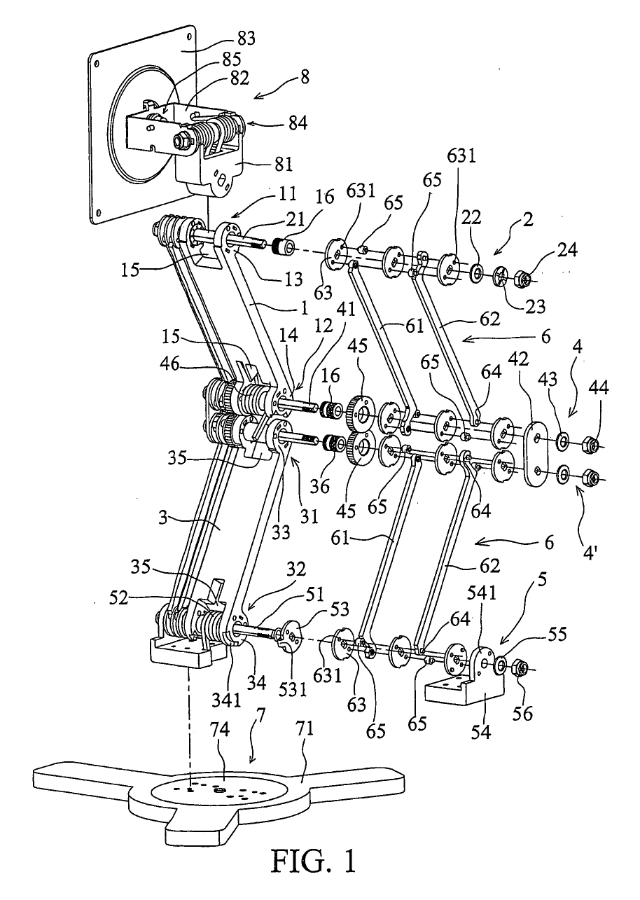

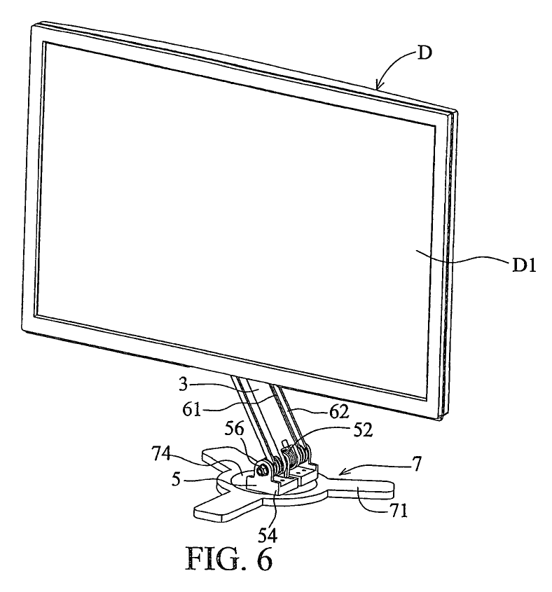

Referring to FIG. 1 to FIG. 6, the elevator support structure of an embodiment of the invention for supporting a display unit D (as shown in FIG. 6) comprises a first connecting element 1, a top hinge 2, a second connecting element 3, a first middle hinge 4, a second middle hinge 4′, a bottom hinge 5, a first and second linkages 6, a base 7, and a joint 8.

The first connecting element 1 is a rectangular board, the top hinge 2 is disposed at a first upper end 11 of the first connecting element 1 to connect to the joint 8, and the first middle hinge 4 is disposed at a first lower end 12 of the first connecting element 1 to connect to the second connecting element 3. As show in FIG. 1, a pair of first upper extended parts 13 and a pair of first lower extended parts 14 are respectively extended from sides of the first upper end 11 and the first lower end 12, and notches 15 are formed between each pair of extended parts. In the embodiment, the first connecting element 1 is a zinc alloy cast, and first sleeves 16 are disposed in the pair of first upper extended parts 13 and the pair of first lower extended parts 14, respectively.

Referring to FIG. 1, the joint 8 has a mount 81 disposed in the notch 15, wherein a first axial bar 21 of the top hinge 2 passes through the mount 81, the first sleeve 16 in the pair of first upper extended parts 13, three horizontally arranged upper spacers 63, at least one resilient element 22, and a washer 23, and connects to an end fixing element 24 (e.g. a chuck nut). Thus, the mount 81 is connected between the pair of first upper extended parts 13 of the first connecting element 1.

The second connecting element 3 is a rectangular board, the second middle hinge 4′ is disposed at a second upper end 31 of the second connecting element 3 to connect to the first connecting element 1, and the bottom hinge 5 is disposed at a second lower end 32 of the second connecting element 3 to connect to the base 7. As show in FIG. 1, a pair of second upper extended parts 33 and a pair of second lower extended parts 34 are respectively extended from sides of the second upper end 31 and the second lower end 32, and notches 35 are formed between each pair of extended parts. In this embodiment, the second connecting element 3 is a zinc alloy cast, and second sleeves 36 are disposed into the pair of second upper extended parts 33 and the pair of second lower extended parts 34, respectively.

The first middle hinge 4 is pivotally connected to the first lower end 12 of the first connecting element 1 and the second middle hinge 4′ is pivotally connected to the second upper end 31 of the second connecting element 3. As shown in FIG. 1, the first middle hinge 4 and the second middle hinge 4′ respectively have a second axial bar 41 passing through the notch 15 of the first connecting element 1 and the notch 35 of the second connecting element 3, the first sleeve 16 in the first lower extended part 14 and the second sleeve 36 in the second upper extended part 33, three upper spacers 63 and three lower spacers 63 which are horizontally arranged, a linking element 42, and at least one resilient element 43, and connects to an end-fixing element 44 (e.g. a chuck nut). Also, the first connecting element 1 and the second connecting element 3 are connected by the linking element 42.

The first sleeve 16 and the second sleeve 36 are respectively squeezed into the transmission elements 45 (e.g. gear wheels). Alternatively, one of the transmission elements 45 is disposed between the pair of the first lower extended parts 14 of the first connecting element 1, the other transmission element 45 is disposed between the pair of the second upper extended parts 33 of the second connecting element 3, and the transmission elements 45 engage with each other. Thus, the first connecting element 1 and the second connecting element 3 can be moved together.

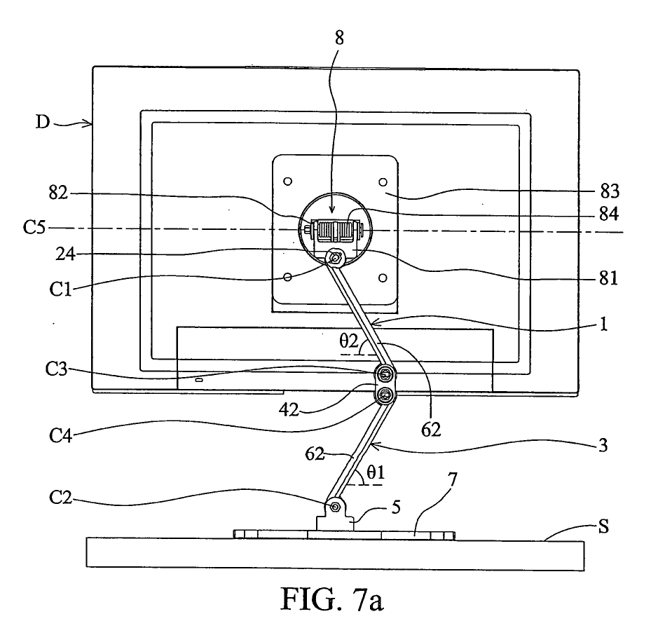

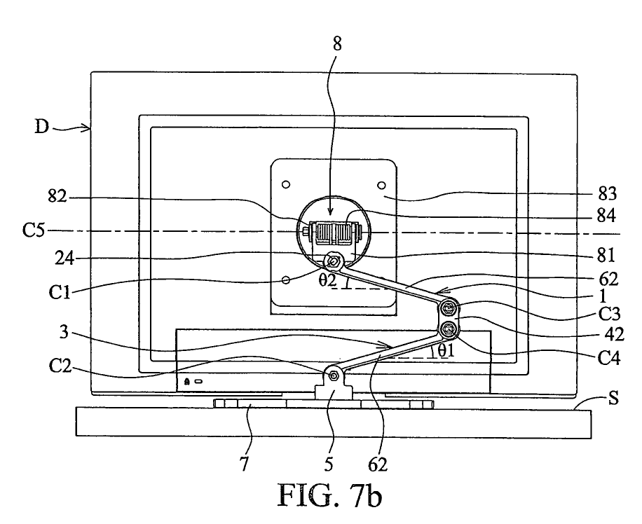

The upper transmission element 45, engaging with the lower transmission element 45, rotates in a counterclockwise direction when the first connecting element 1 rotates in a counterclockwise direction around the first middle hinge 4. Thus, the second connecting element 3, moved together with the lower transmission element 45, rotates in a clockwise direction around the bottom hinge 5. When an angle formed between the first connecting element 1 and the second connecting element 3 is changed, an angle formed between the linking element 42 and the base 7 is kept constant due to linkages disposed at sides of the first connecting element 1 and the second connecting element 3 (as shown in FIGS. 7a and 7b).

The first torsional spring 46 encircles the second axial bar 41 of the first middle hinge 4 connected to the first lower end 12 of the first connecting element 1, and two ends of the first torsional spring 46 respectively abut against the first connecting element 1 and the second axial bar 41 of the second middle hinge 4′.

The bottom hinge is pivotally connected to the second lower end 32 of the second connecting element 3 and the base 7. As shown in FIG. 1, a third axial bar 51 of the bottom hinge 5 passes through the notch 35 of the second lower end 32 of the second connecting element 3, a second torsional spring 52, the pair of second lower extended parts 34, a stop piece 53, three horizontally arranged lower spacers 63, a side wall 541 provided with a support 54, and at least one resilient element 55, and connects to an end-fixing element 56 (e.g. a chuck nut). The end-fixing element 56 is used for tightening the above elements, allowing the support 54 to rotate with respect to the second connecting element 3 or to stop.

A slide 531 extended inward from edges of the stop piece 53 is disposed in a top of a curved sliding groove 341 of each second lower extended part 34. Thus, the second connecting element 3 is inclined to the supports 54 at a predetermined angle. The second torsional spring 52 encircles the third axial bar 51 of the bottom hinge 5 at the second lower end 32 of the second connecting element 3. Two ends of the second torsional spring 52 respectively abut against the second connecting element 3 and the support 54. In this embodiment, the total spring force from the first torsional spring 46 and the second torsional spring 52 counteracts the weight of the display unit D (as shown in FIG. 6). Thus, the user can easily elevate the display unit D with respect to the base 7 and avoid the display 100 from tipping over.

Referring to FIG. 1, the first and the second linkage 6, respectively, are connected to the first connecting element 1 and the second connecting element 3, wherein each linkage 6 has an inner bar 61 and an outer bar 62 parallel to the inner bar 61. A top end and a bottom end of the inner bar 61 are respectively sandwiched by three upper and lower spacers 63. Similarly, a top end and a bottom end of the outer bar 62 are respectively sandwiched by three other upper and lower spacers 63. Axial pins 64 of the inner bar 61 and the outer bar 62 are inserted into two holes 631 disposed in the spacers 63 in a radial direction. The adjacent holes 631 of the spacers 63 are pivotally connected to intermediary pins 65. As shown in FIG. 1, specifically, the three lower spacers 63 are serially connected by inserting the intermediary pin 65 and the axial pin 64 of the outer bar 62 into the holes 631 so that the top and bottom ends of the outer bar 62 are pivotally connected to the upper and lower holes 631. Also, the axial pin 64 of the inner bar 61 and the intermediary pin 65 are inserted into the hole 631 so that the top and bottom ends of the inner bar 61 are pivotally connected to the upper and lower holes 631. Thus, the first axial bar 21, the second axial bar 41, and the third axial bar 51 can pass through the spacers 63 to be moved together.

The transmission elements 45 connected between the first connecting element 1 and the second connecting element 3 engage with each other to rotate in opposite directions when the first connecting element 1 and the second connecting element 3 respectively rotate around of the first middle hinge 4 and the bottom hinge 5. When a height of the display unit D is reduced, the first connecting element 1 rotates around the first middle hinge 4 and the second middle hinge 4′ in a counterclockwise direction, one of the transmission elements 45 disposed at the first lower end 12 of the first connecting element 1 rotates in a counterclockwise direction, the other transmission element 45 disposed at the second upper end 31 of the second connecting element 3 rotates in a clockwise direction, and the second connecting element 3 connected to the other transmission element 45 rotates around the bottom hinge in a clockwise direction. In particularly speaking, the inner bar 61 and the outer bar 62 respectively push and the spacers 63 abutting the top hinge 2 and the first middle hinge 4 to accomplish the counterclockwise of the first connecting element 1 and maintain the orientation of the mount 81 of the joint 8.

Similarly, to accomplish the clockwise of the second connecting element 3, the inner bar 61 and the outer bar 62, respectively push and pull the spacers 63 abutting the second middle hinge 4′ and the bottom hinge 5. The linking element 42 covers the transmission elements 45 and connects to the first connecting element 1 and the second connecting element 3. In this embodiment, the transmission elements 45 are gear wheels with 1:1 gear ratio, and rotate in opposites directions to maintain the angle at which the linking elements 42 are inclined to the base 7. Thus, the first and second linkages 6 eliminate a horizontal movement of the linkages arising from rotation of each connecting elements so that the joint 8 is inclined to the linking element 42 at the original angle.

Basically, the first and second linkages 6 serve as a four-bar mechanism. The first linkage 6 is connected between the top hinge 2 at the first upper end 11 of the first connecting element 1 and the first middle hinges 4 at the first lower end 12 of the first connecting element 1, and the second linkage 6 is connected between the second middle hinge 4′ at the second upper end 31 of the second connecting element 3 and the bottom hinge 5 at the second lower end 32 of the second connecting element 3. In the four-bar mechanism, however, the inner bar 61 and the outer bar 62 are not necessarily disposed at the same side of the first connecting element 1 and the second connecting element 3. Instead, the inner bar 61 and the outer bar 62 can be separately disposed at different sides of the first connecting element 1 and the second connecting element 3. In this embodiment, the resilient elements 22, 43, 55 may be shaped like disks, waves, or helical springs to provide an appropriate thrust.

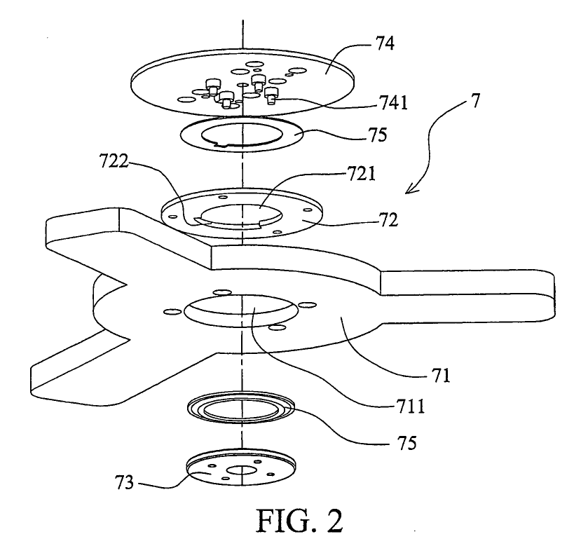

Referring to FIG. 2, the second connecting element 3 is connected to the base 7 via the pair of supports 54 connected to the bottom hinge 5. A center of a main body 71 of the base 7 has a stepped through hole 711 connected to a fixing part 72. A sector-shaped concave cut 722 is outwardly extended from edges of an opening 721 of the fixing part 72. A rotary disk 74 is disposed in the through hole 711, while a bottom cover 73 is affixed to the rotary disk 74 through well-known connecting elements (e.g. screws) so that the rotary disk 74 is rotatable on the main body 71. Furthermore, the pair of supports 54 is connected to the rotary disk 74 so that the entire elevator support structure is rotatable on the base 7. A protrusion 741 corresponding to the sector-shaped concave cut 722 is downwardly extended from a bottom of the rotary disk 74 so that the rotation of the rotary disk 74 is limited. One of the wear resistant rings 75 is disposed between the rotary disk 74 and the fixing part 72 for reducing function, and the other wear resistant ring 75 is disposed between the bottom cover 73 and the fixing part 72 for reducing friction.

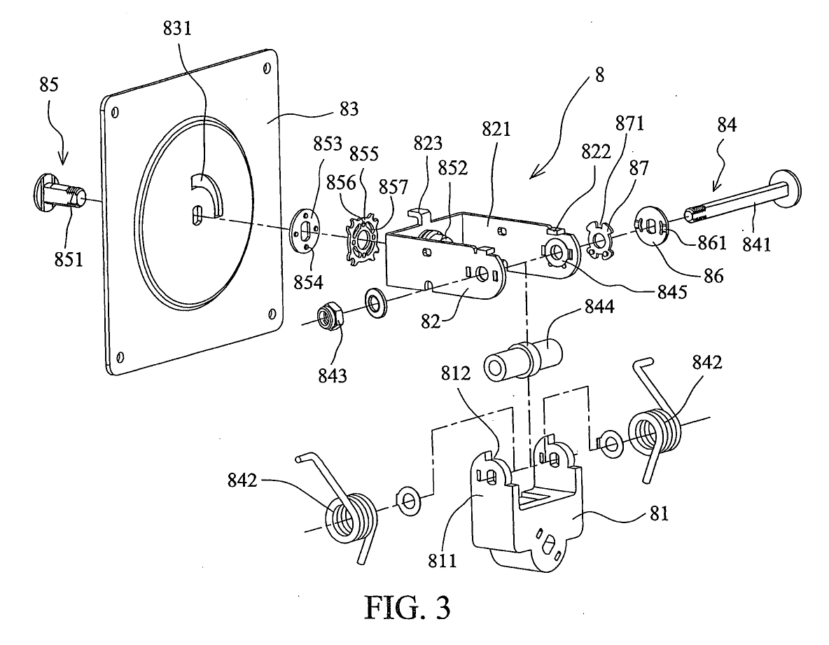

Referring to FIG. 3, the first connecting element 1 is connected to the joint 8 via the top hinge 2, and the mount 81 is disposed between the pair of upper extended parts 13. The mount 81 is provided with a pair of extensions 811 which is a U-shaped support, and an adjusting element 82 is pivotally connected between the pair of extensions 811 to swing up and down. In this embodiment, the adjusting element 82 is connected to a frame 83, and the frame 83 is connected to the display unit D (as shown in FIGS. 7a and 7b).

A pair of arms 821, backwardly extended from the adjusting element 82, is connected to the pair of extensions 811. Also, a fourth axial bar 841 of a hinge 84 passes through the pair of extensions 811, the pair of arms 821, and at least one torsional spring 842 between the pair of extensions 811 and the pair of arms 821, and connects to an end-fixing element 843 (e.g. a chuck nut) so that the swinging positions of the adjusting element 82 with respect to the mount 81 can be adjusted in a non-stage way. Furthermore, at least one torsional spring 842 encircles a tube 844, the fourth axial bar 841 passes through the tube 844, and two ends of the torsional spring 842 respectively abut against the mount 81 and the adjusting element 82. Such an arrangement saves labor during adjustment of the position of the display unit D. Furthermore, edges of the pair of the extensions 811 are provided with a pair of curved concave cuts 812, and a pair of stoppers 822 corresponding to the pair of curved concave cuts 812 is inwardly extended from the pair of arms 821 of the adjusting element 82 to limit an up and down adjustment angle, wherein wear rings 845 are disposed between the pair of the extensions 811 and the pair of arms 821 to avoid excessive abrasion.

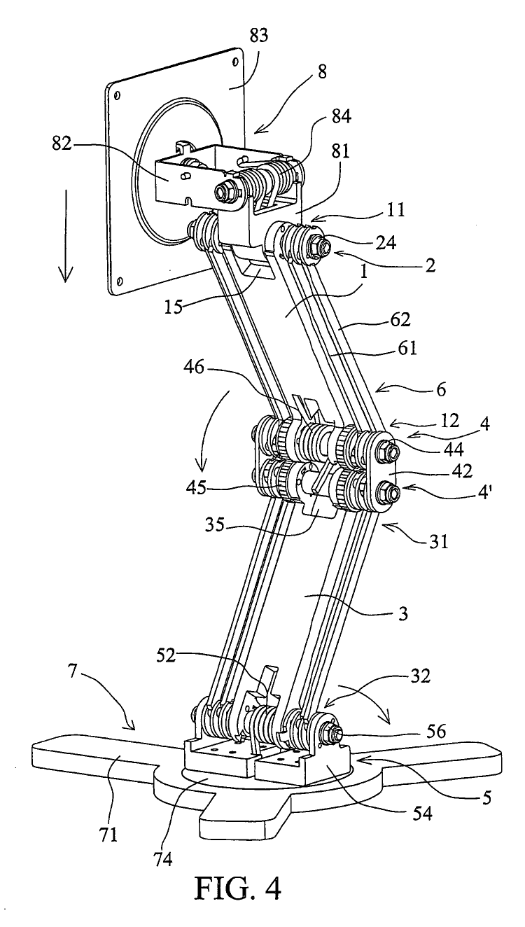

A rotary hinge 85 is disposed between the frame 83 and the adjusting element 82, wherein a fifth axial bar 851 passes through the frame 83 and the adjusting element 82, and connects to the an end-fixing element 852 (e.g. a chuck nut). The frame 83 is rotatably relative to the adjusting element 82, and a slid 823 is extended from the adjusting element 82 and inserted into a curved slot 831 of the frame 83 to limit the rotation. Referring to FIG. 4, a combination of the elevator support structure, the base 7, and the joint 8 is shown. To divide the rotation of the frame 83 into multi-stages, a fifth axial bar 851 passes through a rotary piece 853, the positioning piece 855 is fixed in front of the adjusting element 82 via protrusions 854 extended from an inner surface of the rotary piece 853, positioning holes 856 are correspondingly disposed to the protrusions 854, and a sliding groove 857 is disposed between the adjacent positioning holes 856. During rotation of the frame 83, the protrusions 854 protrude from the positioning holes 856 through the sliding groove 857 into the adjacent positioning holes 856 wherein the protrusions 854 are held to indicate a position of the frame 83.

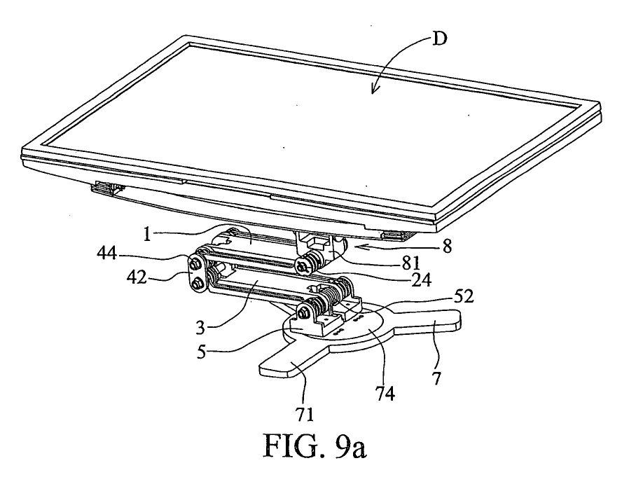

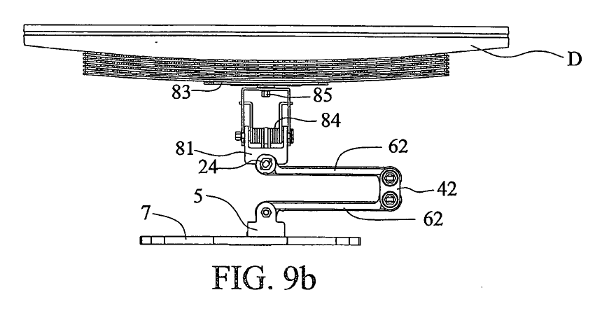

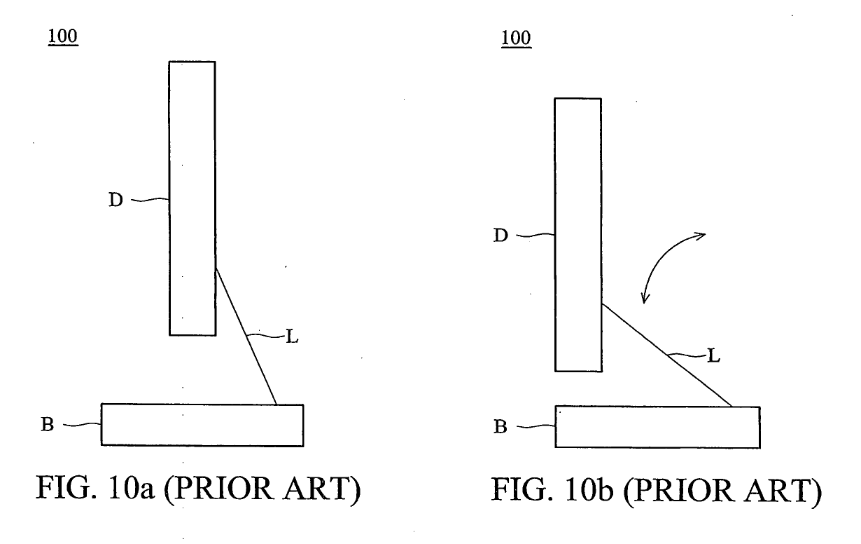

The fourth axial bar 841 sequentially passes through a fastening ring 86 and an engaging ring 87 fixed disposed at the outside of the pair of arms 821. A pair of tenons 861 is extended from an inner surface of the fastening ring 86, and the engaging ring 87 is provided with two pairs of curve cuts 871. When the adjusting element 82 is rotated upward with the frame 83, the tenons 861 of the fastening ring 86 travel over the edge of the cut 871 to engage with the cut 871. Thus, the frame 83 is substantially parallel with the base 7 as shown in FIGS. 9a and 9b.

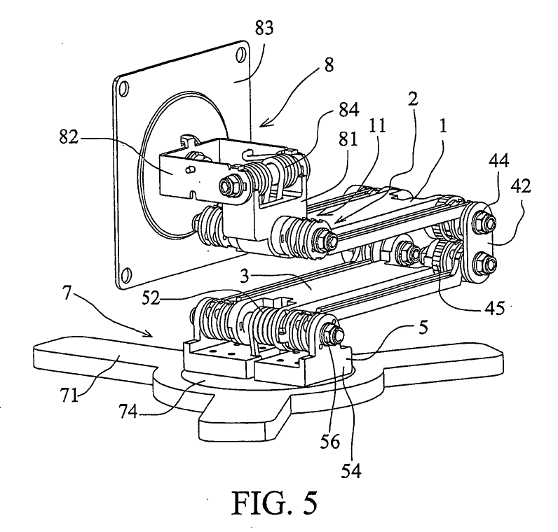

Referring to FIG. 5, when the height of the display unit D is adjusted, the first connecting element 1 and the second connecting element 3 respectively rotate around the first middle hinge 4 and the bottom hinge 5, and the transmission elements 45 connected between the first connecting element 1 and the second connecting element 3 engage with each other to rotate in opposite directions. Also, the first and second linkages 6 rotate in opposite directions in response to rotation of the first connecting element 1 and the second connecting element 3, which maintain the orientation of the joint 8 and keep the linking element 42 of the first and second middle hinges 4, 4′ perpendicular to the base 7.

Referring to FIG. 6, the elevator support structure and the display unit D are combined to form a display device. Note that the joint 8 is sideward connected to the display unit D. Referring to FIGS. 7a and 7b, the transmission elements 45, engaging with each other, drive the first connecting element 1 and the second connecting element 3 of the elevator support structure to rotate in opposite directions and increase the elevated velocity. The first and second linkages 6, in response to rotation of the first connecting element 1 and the second connecting element 3, are capable of elevating the display unit D without any forward-backward movement.

For the above description, the display device of FIGS. 7a and 7b is combined with the elevator support structure and the display unit D, wherein the elevator support structure supports the display unit D. Referring to the foregoing description and FIGS. 6, 7a, and 7b, the base 7 of the elevator support structure is disposed on a plane S, and the display unit D is provided with a displaying area D1. The displaying area D1 and the elevator support structure are disposed on opposite sides (as shown in FIG. 6), and the displaying area D1 is substantially perpendicular to the plane S. The elevator support structure of the invention allows the display unit D to linearly move relative to the base 7 in a first direction (the direction is perpendicular to plane S) to achieve vertical movement.

The first connecting element 1 is pivotally connected to the display unit D through the top hinge 2 and the joint 8, wherein the first connecting element 1 rotates relative to the display unit D around a first axis C1. The second connecting element 3 is pivotally connected to the base 7 through the bottom hinge 5, wherein the second connecting element 3 rotates relative to the base 7 around a second axis C2. The first and second middle hinges 4, 4′ are pivotally connected to the first connecting element 1 and the second connecting element 3, wherein the first connecting element 1 rotates relative to the first middle hinge 4 around a third axis C3, the second connecting element 3 rotates relative to the second middle hinge 4′ around a fourth axis C4.

Referring to FIGS. 7a and 7b, the joint 8 is pivotally connected to the display unit D and the first connecting element 1 so that the display unit D rotates around a fifth axis C5 through the joint 8. In this embodiment, the first, second, third, and fourth axes C1-C4 are perpendicular to the display area D1 of the display unit D, and the fifth axis is perpendicular to the first axis C1 and parallel to the display area D1 and the plane S. The first connecting element 1 is coupled with the second connecting element 3 via the transmission elements 45 so that the first connecting element 1 is inclined to the plane S at a first angle θ₁, and the second connecting element 3 is inclined to the plane S at a second a second angle θ₂ which is equal to the first angle θ₁.

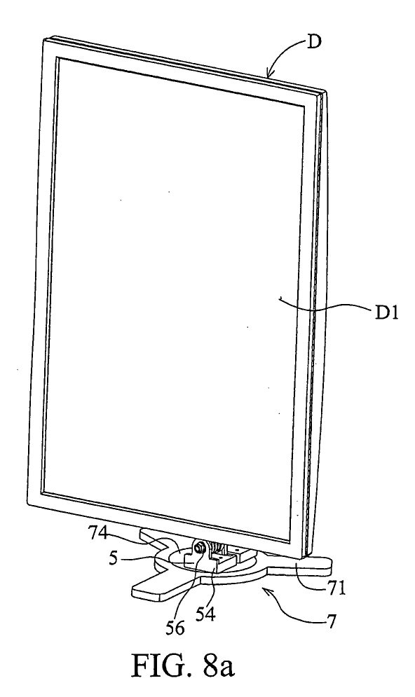

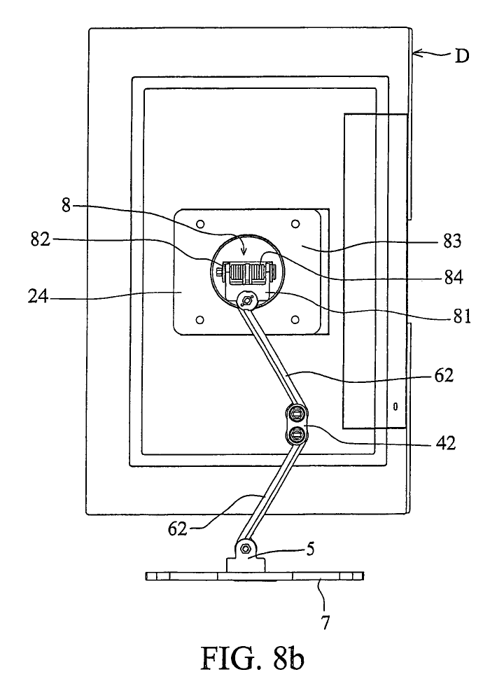

Referring to FIG. 8a, a stereogram of the display unit D and the frame 83 of the joint 8 rotating with the adjusting element 82, and FIG. 8b, a rear view of the display unit D and the frame 83 of the joint 8 rotating with the adjusting element 82 are shown. When the curved slot 831 rotates with the frame 83 (as shown in FIG. 3), the slid 823 of the adjusting element 82 contacts the other end of the curved slot 831. Thus, the display unit D can be transformed from the so-called “Landscape” position (as shown in FIG. 6) to the so-called “Portrait” position (as shown in FIG. 8a).

Referring to FIG. 9a and FIG. 9b, when the adjusting element 82 and the frame 83 are rotated upward with the display unit D, the tenons 861 of the fastening ring 86 travel over the edge of one of the cuts 871 to engage with the other cut 871. Thus, the frame 83 is substantially parallel with the base 7. Besides, the elevator support structure is folded to form a compact volume, which is favorable for packing the display device to reduce the transport cost.

For the above description, the invention provides an elevator support structure to avoid the display device tipping over during height adjustment, which appropriately reduces the size of the base, significantly reduces the manufacturing cost, and improves user convenience.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An elevator support structure, comprising:
a first connecting element having a first lower end and a first upper end;
a second connecting element having a second lower end and a second upper end connected to the first lower end of the first connecting element;
a pair of transmission elements respectively connected the first lower end of the first connecting element and the second upper end of the second connecting element to rotate in opposite directions;
a top hinge pivotally connected to the first upper end of the first connecting element;
a joint connected to the top hinge;
a first middle hinge pivotally connected to the first lower end of the first connecting element and one of the transmission elements;
a second middle hinge pivotally connected to the second upper end of the second connecting element and the other of the transmission elements;
a linking element connected to the first connecting element and the second connecting element;
a base;
a bottom hinge pivotally connected to the second lower end of the second connecting element and the base; and
a first linkage connected the top hinge and the first middle hinge; and
a second linkage connected the second middle hinge and the bottom hinge;
wherein when the pair of the transmission elements are rotated in opposite directions, the first and second connecting elements are respectively rotated with respect to the first and second hinges, and the joint and the linking element are vertically moved with respect to the base.

2. The elevator support structure as claimed in claim 1 further comprising:
a first lower extended part extended from the first lower end and encircling a first sleeve of the first middle hinge;
a second upper extended part extended from the second upper end and encircling a second sleeve of the second middle hinge;
wherein the pair of transmission elements respectively encircle the first and second sleeves and engage with each other.

3. The elevator support structure as claimed in claim 1, wherein the top hinge comprises a spacer, a resilient element, an end-fixing element, and an axial bar which sequentially passes through the first upper end of the first connecting element, the joint disposed in a notch of the first upper end of the first connecting element, the spacer, and the resilient element, and connects to the end-fixing element.

4. The elevator support structure as claimed in claim 1, wherein the first middle hinge comprises an upper spacer, a resilient element, an end-fixing element, and an axial bar which sequentially passes through the first lower end of the first connecting element, the spacer, the linking element, and the resilient element, and connects to the end-fixing element.

5. The elevator support structure as claimed in claim 1 further comprising:
a first torsional spring encircling the first middle hinge and respectively abutting against the first connecting element and the second middle hinge;
a second torsional spring encircling the bottom hinge and abutting against the second connecting element; and
a support disposed on the base and abutted against with the second torsional spring.

6. The elevator support structure as claimed in claim 1, wherein the joint further comprises:
a mount disposed on the first upper end of the first connecting element and provided with a pair of extensions;
an adjusting element pivotally connected with the pair of extensions; and
a frame connected to the adjusting element.

7. A display, disposed on a plane, comprising:
a display unit having a display area;
an elevator support structure for supporting the display unit comprising:
a base disposed on the plane;
a first connecting element pivotally connected to the display unit, wherein the first connecting element rotates relative to the display unit around a first axis, and the first axis is perpendicular to the display area;
a second connecting element connected to the base, wherein the second connecting element rotates relative to the base around a second axis, and the second axis is perpendicular to the display area; and
a middle hinge assembly pivotally connected to the first connecting element and the second connecting element, wherein the first connecting element rotates relative to the middle hinge assembly around a third axis, the second connecting element rotates relative to the middle hinge around a fourth axis, and the third and fourth axes are perpendicular to the display area.

8. The display as claimed in claim 7, wherein the second connecting element is inclined to the plane at a second angle when the first connecting element is inclined to the plane at a first angle which is equal to the second angle.

9. The display as claimed in claim 7, wherein the elevator support structure further comprises a joint pivotally connected to the display unit and a first connecting element, the display unit rotates around a fifth axis via the joint, and the fifth axis is perpendicular to the first axis and parallel to the display area.

10. The display as claimed in claim 7, wherein the base comprises a main body and a rotary disk connected to the second connecting element and rotatable relative to the main body.
